(19) United States
(12) Patent Application Publication
(10) Pub. No.: US 2014/0338160 A1
(43) Pub. Date: Nov. 20, 2014

(54) SPRING CLIP ASSEMBLY

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: WEI-TING CHIEN, New Taipei (TW); RUI-TAO CAO, Shenzhen (CN); PING LI, Shenzhen (CN); YONG-JUN YU, Shenzhen (CN)

(73) Assignees: HON HAI PRECISION INDUSTRY CO., LTD., New Taipei (TW); HONG FU JIN PRECISION INDUSTRY (ShenZhen) Co., LTD, Shenzhen (CN)

(21) Appl. No.: 14/158,852

(22) Filed: Jan. 19, 2014

(30) Foreign Application Priority Data
May 17, 2013 (CN) 2013101820963

(51) Int. Cl. F16B 2/24

(52) U.S. Cl. CPC F16B 2/245
USPC 24/530

(57) ABSTRACT

A spring clip assembly includes a spring clip and a mounting plate. The spring clip includes an elastic abutting tab, a connecting plate connected to the abutting tab, and an inclined tab angled with respect to the connecting plate. The mounting plate is connected to the spring clip. The mounting plate includes a base plate, and a first positioning portion and a positioning portion connected with the base plate at opposite sides. The base plate defines a through hole. The first positioning portion and the base plate cooperatively define a first gap. The second positioning portion and the base plate cooperatively define a second gap. The abutting tab is engaged with the through hole after the connecting plate is inserted into the first gap and then received in the second gap.

### FIELD

The present disclosure relates to spring clip assemblies, and particularly, to a spring clip assembly in which a spring clip and a shielding case are assembled without bolts.

### BACKGROUND

Many electronic devices, such as mobile phones, tablet computers, and personal digital assistants, include a circuit board and a shielding case. The shielding case includes a grounded end electrically connected to ground, and a spring clip secured to the circuit board. Thus, the circuit board is connected to ground via the grounded end of the shielding case to conduct static electricity to ground.

In some of the electronic devices, a spring clip and a shielding case are secured together by bolts, which substantially increases the manufacturing expense because of the extra machining of the spring clip, as well as the costs of the bolts and the time spent actually bolting the spring clip and the shielding case to each other.

### BRIEF DESCRIPTION OF THE DRAWINGS

Many aspects of the embodiments with this disclosure can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the views. The description is not to be considered as limiting the embodiments described herein.

FIG. 1 is an isometric view of a spring clip assembly in accordance with an exemplary embodiment.

FIG. 2 is similar to FIG. 1, but showing the spring clip assembly in another perspective.

FIG. 3 is a disassembled isometric view of the spring clip assembly of FIG. 1.

FIG. 4 is similar to FIG. 3, but showing the spring clip assembly in another perspective.

FIG. 5 is a cross-sectional view taken along line V-V of FIG. 1.

### DETAILED DESCRIPTION

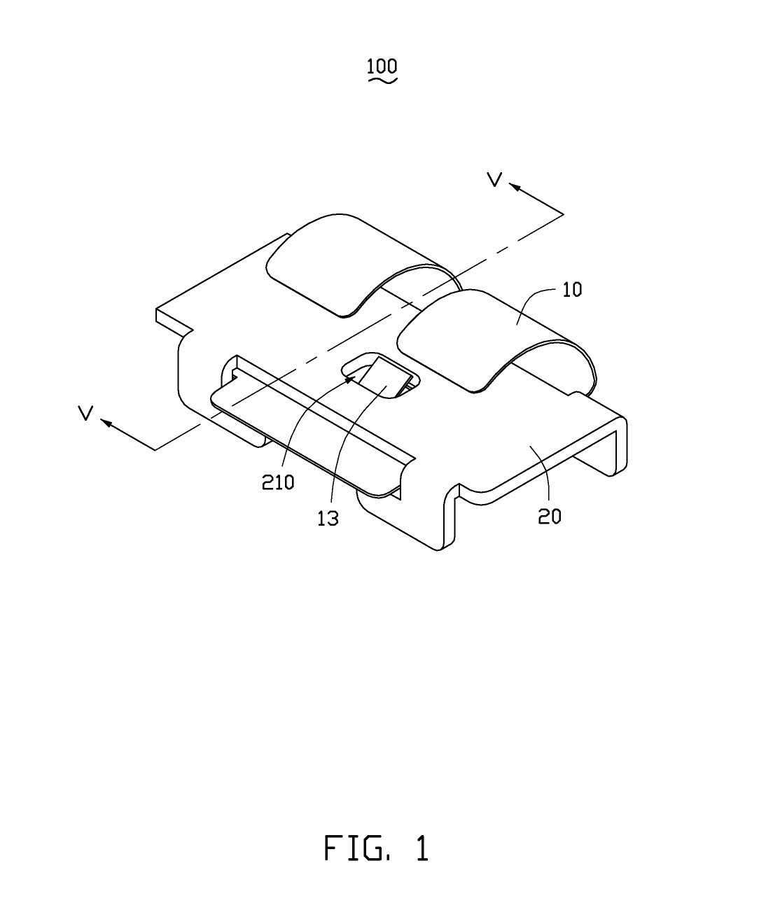

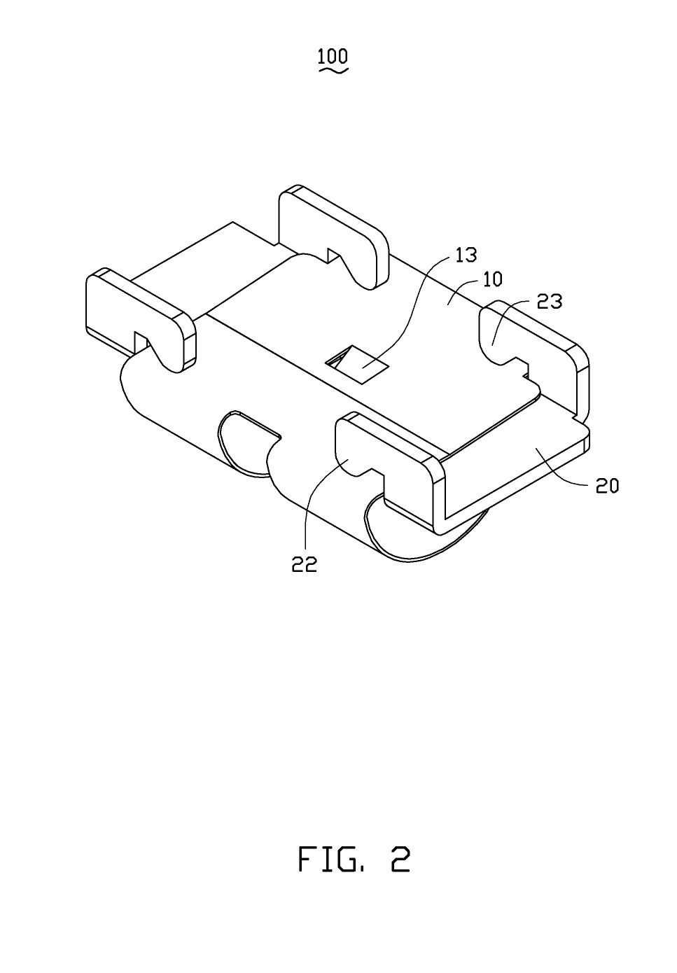

FIGS. 1-2 illustrate a spring clip assembly 100 in accordance with an exemplary embodiment. The spring clip assembly 100 includes a spring clip 10 and a mounting plate 20 connected to the spring clip 10. In the embodiment, the mounting plate 20 is a shielding case, and a circuit board (not shown) is connected to a grounded portion of the shielding case via the spring clip 10, to conduct static electricity to the ground.

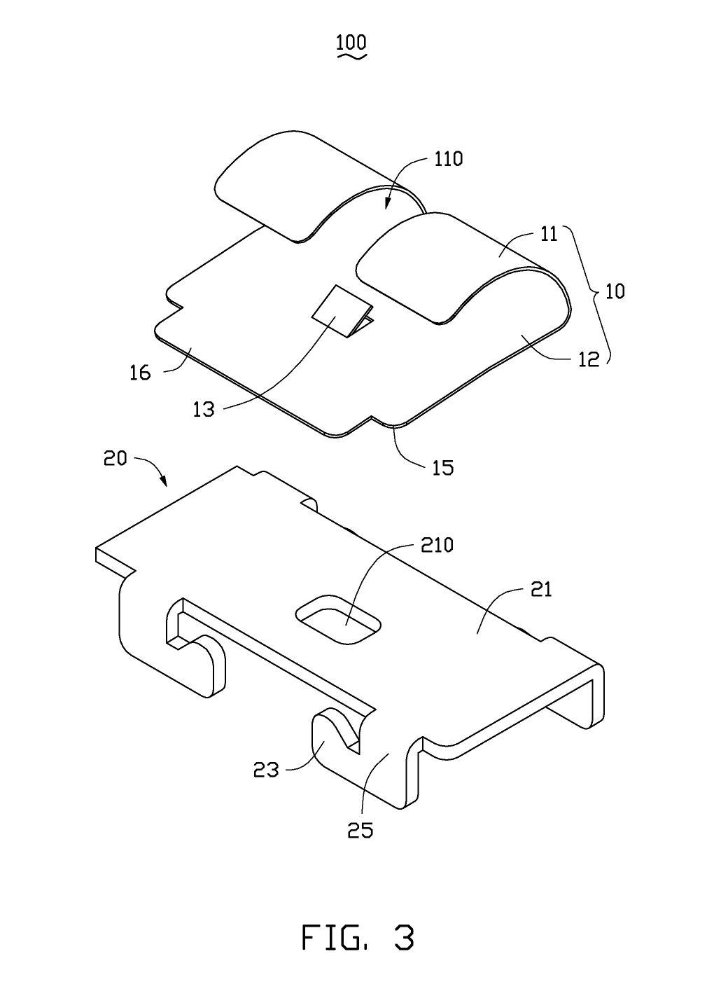

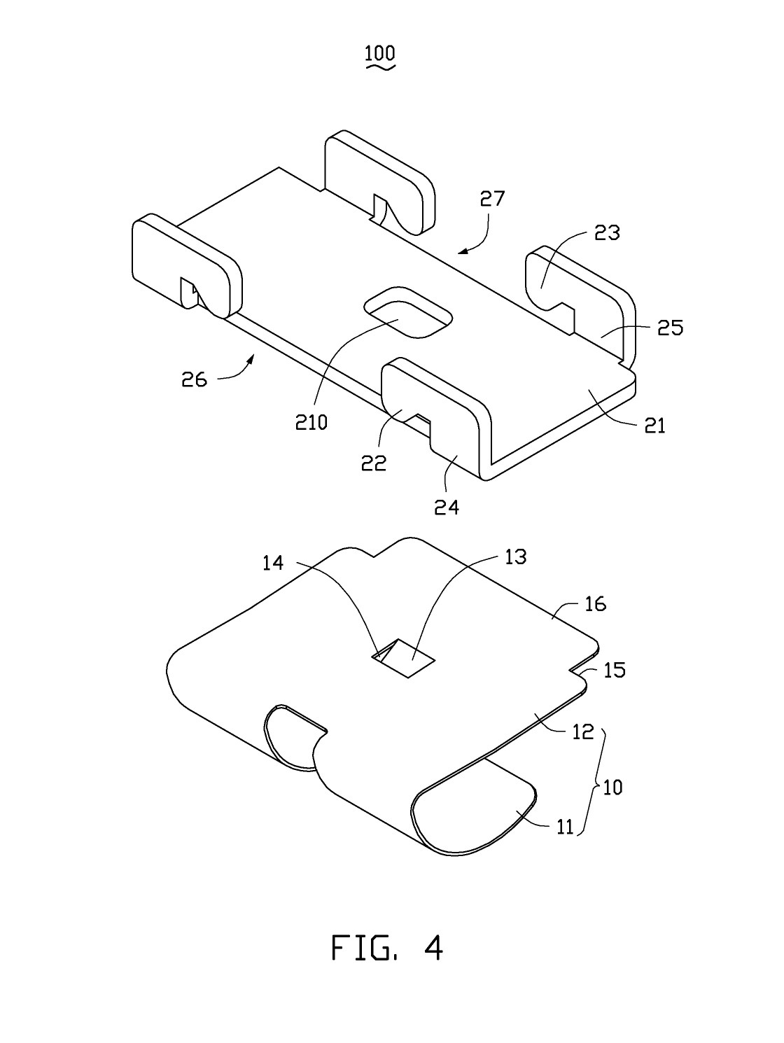

FIGS. 3-4 show that the spring clip 10 includes at least one elastic abutting tab 11 and a connecting plate 12 integrally formed with the abutting tab 11. The abutting tab 11 is connected to the circuit board. In the embodiment shown, the spring clip 10 includes two abutting tabs 11, and the two abutting tabs 11 are spaced from each other to form a slot 110 therebetween. The connecting plate 12 defines a central rectangular latching hole 14. An elastic inclined tab 13 is connected to an edge of the latching hole 14, and is angled with respect to the plane of the connecting plate 12. The inclined tab 13 can cover the latching hole 14 when pressed. A flange portion 16 protrudes from the connecting plate 12 at an end 15 away from the abutting tab 11. The width of the flange portion 16 is less than the width of the end 15 of the connecting plate 12.

The mounting plate 20 includes a base plate 21, two first legs 24 protruding perpendicularly from a side of the base plate 21, and two second legs 25 protruding perpendicularly from an opposite side of the base plate 21. A first positioning portion 22 protrudes from each first leg 24, and the two first positioning portions 22 face each other. A second positioning portion 23 protrudes from each second leg 25, and the two second positioning portions 23 face each other. In the illustrated embodiment, each of the first and the second legs 24, 25 is perpendicular to the base plate 21. The first positioning portions 22 are spaced away from the base plate 21, and a first gap 26 is defined between the first positioning portions 22 and the base plate 21. The second positioning portions 23 are spaced away from the base plate 21, and a second gap 27 is defined between the second positioning portions 23 and the base plate 21. Both the first gap 26 and the second gap 27 are greater than the thickness of the connecting plate 12. The base plate 21 further defines a through hole 210.

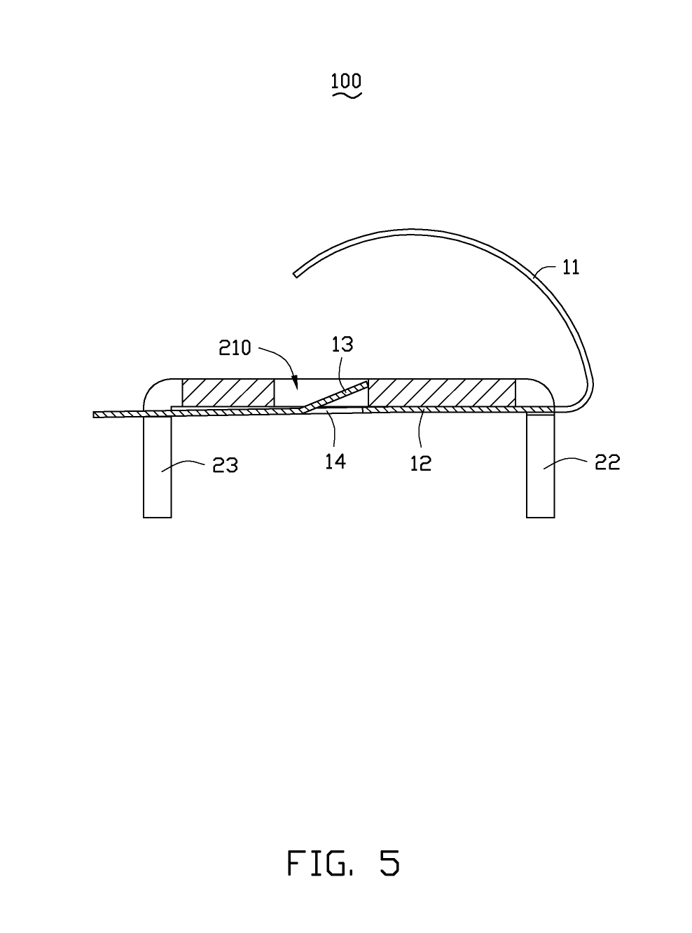

FIG. 5 shows that when the flange portion 16 is inserted into the first gap 26, the inclined tab 13 is pressed to cover the latching hole 14 of the connecting plate 12. After the flange portion 16 is received in the second gap 27, the end 15 of the connecting plate 12 abuts against the two second legs 25, and the inclined tab 13 rebounds and the distal end engages with the edge of the through hole 210. Thus, the spring clip 10 is engaged with the mounting plate 20. In the embodiment, the flange portion 16 is angled with respect to the connecting plate 12, and abuts against an end of the second positioning portions 23 when the spring clip 10 is engaged with the mounting plate 20.

The user can further push the inclined tab 13 to allow disengagement from the through hole 210, and the spring clip 10 may be manually pulled to disengagement from the mounting plate 20.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the plain meaning of the terms in which the appended claims are expressed.

What is claimed is:

1. A spring clip assembly comprising:
a spring clip comprising at least one elastic abutting tab, a connecting plate connected to the abutting tab, and an inclined tab angled with respect to the connecting plate; and
a mounting plate connected to the spring clip, the mounting plate comprising a base plate, and at least one first positioning portion and at least one positioning portion connected with the base plate at opposite sides, the base plate defining a through hole, the first positioning portion and the base plate cooperatively defining a first gap, the second positioning portion and the base plate cooperatively defining a second gap, the abutting tab being engaged with the through hole after the connecting plate is inserted into the first gap and then received in the second gap.

2. The spring clip assembly of claim 1, wherein the connecting plate is integrally formed with the abutting tab.

3. The spring clip assembly of claim 2, wherein the spring clip comprises two abutting tabs, and the two abutting tabs are spaced from each other to form a slot therebetween.

4. The spring clip assembly of claim 1, wherein the connecting plate defines a rectangular latching hole at a center thereof, and the inclined tab is connected to an edge of the latching hole which covers the latching hole when the connecting plate is inserted into the first gap.

5. The spring clip assembly of claim 1, wherein the mounting plate further comprise at least one first leg protruding perpendicularly from a side of the base plate, and at least one second leg protruding perpendicularly from an opposite side of the base plate, the first positioning portion is connected to the base plate via the first leg, and the second positioning portion is connected to the base plate via the second leg.

6. The spring clip assembly of claim 5, wherein a flange portion protrudes from the connecting plate at an end away from the abutting tab, a width of the flange portion is less than a width of the end of the connecting plate, the end of the connecting plate is abutted against the second leg after the flange portion is received in the second gap.

7. The spring clip assembly of claim 6, wherein the flange portion is angled with respect to the connecting plate, and abuts against an end of the second positioning portion after the flange portion is received in the second gap.
